(19) United States
(12) Patent Application Publication
(10) Pub. No.: US 2022/0113801 A1
(43) Pub. Date: Apr. 14, 2022

(54) SPATIAL AUDIO AND HAPTICS

(71) Applicant: Hewlett-Packard Development Company, L.P., Spring, TX (US)

(72) Inventors: Sunil Ganpatrao Bharitkar, Palo Alto, CA (US); Rafael Antonio Ballagas, Palo Alto, CA (US); Kevin Lee Smathers, Palo Alto, CA (US); Sarthak Ghosh, Palo Alto, CA (US); Madhu Sudan Athreya, Palo Alto, CA (US)

(73) Assignee: Hewlett-Packard Development Company, L.P., Spring, TX (US)

(21) Appl. No.: 17/418,898

(22) PCT Filed: Apr. 26, 2019
(86) PCT No.: PCT/US2019/029390

§ 371 Date: Jun. 28, 2021

(51) Int. Cl. G06F 3/01; G06F 3/16

(52) U.S. Cl. CPC G06F 3/016; G06F 3/167

(57) ABSTRACT

An example non-transitory computer-readable storage medium comprises instructions that, when executed by a processing resource of a computing device, cause the processing resource to generate haptics metadata using audio-haptics classification based at least in part on spatial audio associated with a digital environment. The instructions further cause the processing resource to encode the spatial audio with the haptics metadata to generate a rendering package.

### BACKGROUND

A virtual reality environment creates an imaginary environment or replicates a real environment as a virtual, simulated environment. To do this, a combination of software and hardware devices provide auditory, visual, and other sensations to a user to create the virtual reality environment. For example, a virtual reality headset provides auditory and visual sensations that simulate a real environment.

Augmented reality environments are also created by a computing device utilizing a combination of software and hardware devices to generate an interactive experience of a real-world environment. The computing device augments the real-world environment by generating sensory information (e.g., auditory, visual, tactile, etc.) and overlaying it on the real-world environment.

### BRIEF DESCRIPTION OF THE DRAWINGS

The following detailed description references the drawings, in which:

FIG. 1 depicts a computing device for generating haptics signals and/or haptics metadata based at least in part on spatial audio and video according to examples described herein;

FIG. 2 depicts a computing device for generating haptics signals and/or haptics metadata based at least in part on spatial audio and video according to examples described herein;

FIG. 3 depicts a flow diagram of a method that generates haptics signals and/or haptics metadata based at least in part on spatial audio and video according to examples described herein;

FIG. 4 depicts a computer-readable storage medium comprising instructions to generate haptics signals and/or haptics metadata based at least in part on spatial audio and video according to examples described herein;

FIG. 5 depicts a flow diagram of a method that generates haptics signals and/or haptics metadata based at least in part on spatial audio and video according to examples described herein;

FIG. 6 depicts a flow diagram of a method for performing audio-haptics classification based on spatial audio according to examples described herein;

FIG. 7 depicts a flow diagram of a method for performing audio-haptics classification based on spatial audio and video according to examples described herein;

FIG. 8 depicts a flow diagram of a method for performing audio-haptics classification based on spatial audio according to examples described herein; and

FIG. 9 depicts a flow diagram of a method for performing audio-haptics classification based on spatial audio and video according to examples described herein.

### DETAILED DESCRIPTION

Digital environments, like virtual reality environments, augmented reality environments, and gaming environments, provide auditory, visual, tactical, and other sensations to users to create an immersive experience for the user. For example, in a virtual reality environment, a virtual reality headset worn over a user's eyes immerses the user in a visual environment. An audio device, such as speakers or headphones, provides audio associated with the visual environment.

A user's immersive experience can be enhanced by providing tactile sensations to a user in the form of haptic feedback. Haptic feedback (or “haptics”) stimulates a user's sense of touch by providing tactile sensations, which can be contact-based sensations or non-contact-based sensations. Examples of contact-based sensations include vibration, force feedback, and the like. Examples of non-contact-based sensations include airflow (i.e., air vortices), soundwaves, and the like. These tactile sensations are generated by mechanical devices (haptics generating devices or haptic transducers), such as an eccentric rotating mass (ERM) actuator, a linear resonant actuator (LRA), a piezoelectric actuator, a fan, etc.

In digital environments (e.g., virtual reality environments, augmented reality environments, gaming environments, etc.), it may be useful to generate haptics signals and/or haptics metadata based on audio and video associated with the digital environment. The present techniques improve digital environments by combining spatial audio and haptics to provide an enhanced user experience in the context of virtual reality, augmented reality, and gaming. In particular, the present techniques enable synthesizing multi-media information (audio and video) to generate haptics signals and/or metadata of haptics signals (haptics metadata) using an audio-haptics classification approach, such as deep learning.

Spatial audio enables precise localization of audio, for example, relative to the occurrence of an event. For example, if an explosion occurs to the left of a user in a video game environment, spatial audio associated with the explosion is emitted by a speaker or other similar device on the user's left side. This causes the user to be more fully immersed in the video game environment.

According to examples described herein, during content creation, spatial audio and video content is synthesized to generate haptics information as haptics signals or haptics metadata. As used herein, “synthesis” refers to analyzing spatial audio information/data and video content by applying audio-haptics classification to classify audio and associate haptic feedback information with that audio. The haptics information that can later be used during playback to provide haptic feedback to a user. The audio-haptics classification is performed, for example, using artificial intelligence or “deep learning” using a haptic synthesis model having parameters such as amplitude, decay, duration, waveform type, etc.).

During content creation, video content associated with the spatial audio can also be synthesized with the spatial audio to aid in the audio-haptics classification used to generate haptics information. The haptics information can include a mono-track haptics signal, a multi-track haptics signal, and/or haptics metadata. The haptics information can include information indicating the presence or absence of vibration, directional wind, etc. that is used during content rendering (i.e., playback) to generate haptic feedback to a user.

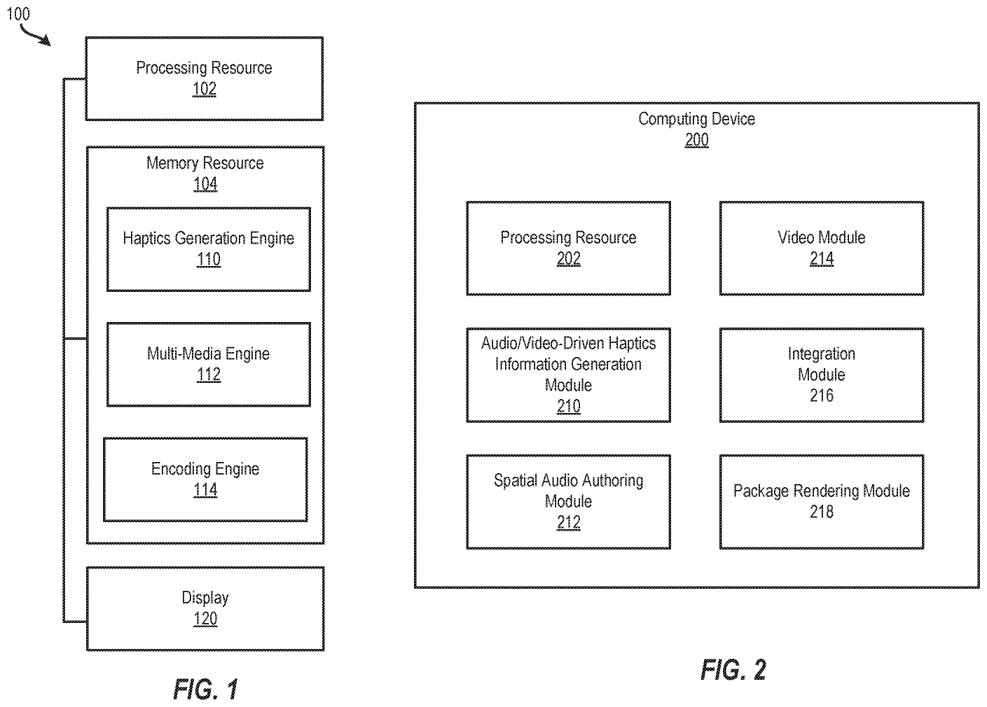

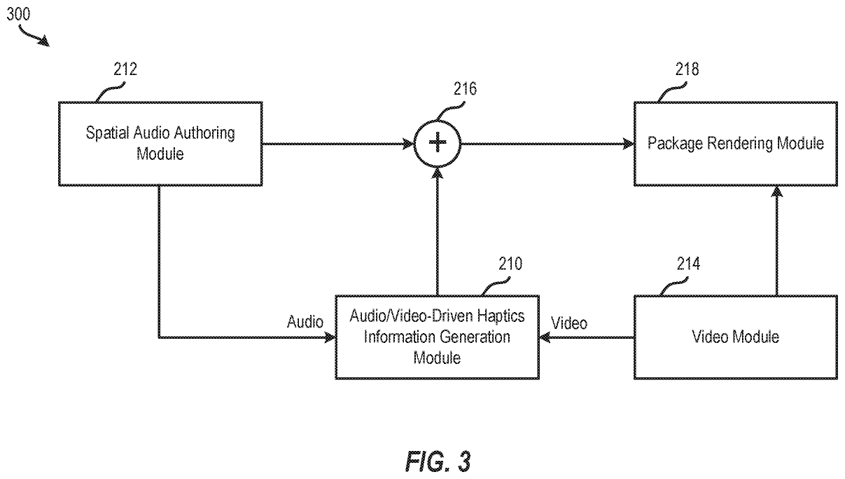

FIGS. 1-3 include components, modules, engines, etc. according to various examples as described herein. In different examples, more, fewer, and/or other components, modules, engines, arrangements of components/modules/engines, etc. can be used according to the teachings described herein. In addition, the components, modules, engines, etc. described herein are implemented as software modules executing machine-readable instructions, hardware modules, or special-purpose hardware (e.g., application specific hardware, application specific integrated circuits (ASICs), field programmable gate arrays (FPGAs), embedded controllers, hardwired circuitry, etc.), or some combination of these.

FIGS. 1-3 relate to components, engines, and modules of a computing device, such as a computing device 100 of FIG. 1 and a computing device 200 of FIG. 2. In examples, the computing devices 100 and 200 are any appropriate type of computing device, such as smartphones, tablets, desktops, laptops, workstations, servers, smart monitors, smart televisions, digital signage, scientific instruments, retail point of sale devices, video walls, imaging devices, peripherals, networking equipment, wearable computing devices, or the like.

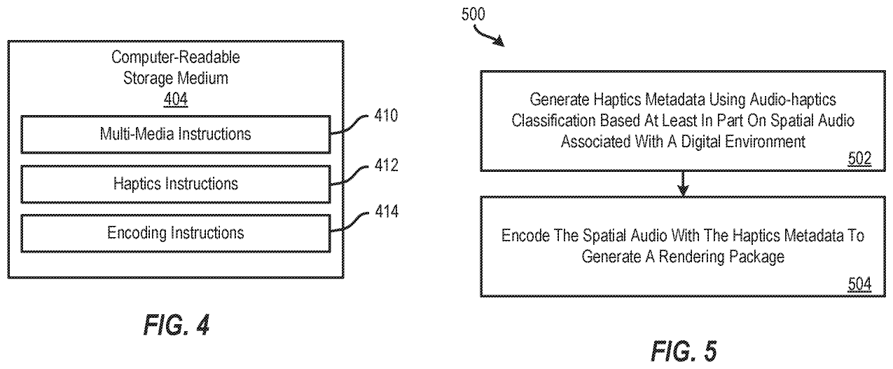

FIG. 1 depicts a computing device 100 for generating haptics signals and/or haptics metadata based at least in part on spatial audio and video according to examples described herein. The computing device 100 includes a processing resource 102 that represents any suitable type or form of processing unit or units capable of processing data or interpreting and executing instructions. For example, the processing resource 102 includes central processing units (CPUs), microprocessors, and/or other hardware devices suitable for retrieval and execution of instructions. The instructions are stored, for example, on a non-transitory tangible computer-readable storage medium, such as memory resource 104 (as well as computer-readable storage medium 404 of FIG. 4), which may include any electronic, magnetic, optical, or another physical storage device that store executable instructions. Thus, the memory resource 104 may be, for example, random access memory (RAM), electrically-erasable programmable read-only memory (EPPROM), a storage drive, an optical disk, and any other suitable type of volatile or non-volatile memory that stores instructions to cause a programmable processor to perform the techniques described herein. In examples, memory resource 104 includes a main memory, such as a RAM in which the instructions are stored during runtime, and a secondary memory, such as a nonvolatile memory in which a copy of the instructions is stored.

Alternatively or additionally in other examples, the computing device 100 includes dedicated hardware, such as integrated circuits, ASICs, Application Specific Special Processors (ASSPs), FPGAs, or any combination of the foregoing examples of dedicated hardware, for performing the techniques described herein. In some implementations, multiple processing resources (or processing resources utilizing multiple processing cores) may be used, as appropriate, along with multiple memory resources and/or types of memory resources.

The computing device 100 also includes a display 120, which represents generally any combination of hardware and programming that exhibit, display, or present a message, image, view, interface, portion of an interface, or other presentation for perception by a user of the computing device 100. In examples, the display 120 may be or include a monitor, a projection device, a touchscreen, and/or a touch/sensory display device. For example, the display 120 may be any suitable type of input-receiving device to receive a touch input from a user. For example, the display 120 may be a trackpad, touchscreen, or another device to recognize the presence of points-of-contact with a surface of the display 120. The points-of-contact may include touches from a stylus, electronic pen, user finger or other user body part, or another suitable source. The display 120 may receive multi-touch gestures, such as “pinch-to-zoom,” multi-touch scrolling, multi-touch taps, multi-touch rotation, and other suitable gestures, including user-defined gestures.

The display 120 can display text, images, and other appropriate graphical content, such as an interface of an application for a digital environment, like a virtual reality environment, an augmented reality environment, and a gaming environment. For example, when an application executes on the computing device 100, an interface, such as a graphical user interface, is displayed on the display 120.

The computing device 100 further includes a haptics generation engine 110, a multi-media engine 112, and an encoding engine 114. According to examples described herein, the haptics generation engine 110 can utilize machine learning functionality to accomplish the various operations of the haptics generation engine 110 described herein. More specifically, the haptics generation engine 110 can incorporate and utilize rule-based decision making and artificial intelligence (AI) reasoning to accomplish the various operations of the haptics generation engine 110 described herein. Electronic systems can learn from data; this is referred to as “machine learning.” A system, engine, or module that utilizes machine learning can include a trainable machine learning algorithm that can be trained. For example, using an external cloud environment or other computing environment, a machine learning system can learn functional relationships between inputs and outputs that are currently unknown to generate a model. This model can be used by the haptics generation engine 110 to perform audio-haptics classification to generate haptics. In examples, machine learning functionality can be implemented as a deep learning technique using an artificial neural network (ANN), which can be trained to perform a currently unknown function.

The haptics generation engine 110 generates haptics information as haptics signals and/or haptics metadata using audio-haptics classification based on spatial audio and/or video associated with a digital environment. Haptics signals are analog or digital signals that cause a haptics device (e.g., a haptics-enabled glove, vest, head-mounted display, etc.) to provide haptic feedback to a user associated with the haptics device. For example, a haptics signal can be a mono-track haptics signal or a multi-track haptics signal. In the case of a multi-track haptics signal, the signal can have N channels, where N is the number of channels. Each of the N channels represents a different haptics signal to cause a haptics device associated with that channel to provide haptic feedback. For example, a first channel is associated with contact-based vibration device, and a second channel is associated with a non-contact-based wind generating device. It should be appreciated that other examples are also possible. Haptics metadata describe a desired haptic effect. For example, haptics metadata can describe the presence or absence of a vibration, a directional wind, etc. According to examples described herein, haptics metadata are used to direct the haptics effect to a corresponding haptic transducer. An example of haptics metadata can define an effect, a direction, an intensity, and a duration (e.g., wind & east & strong & gust of 3-seconds). Another example of haptics metadata can define an effect, a location, and an intensity (e.g., touch & right hand & sharp tap). Other examples of haptics metadata are also possible and within the scope of the present description. During rendering, the metadata are extracted; signal processing using on a machine learning (or deep learning) model is performed to synthesize the haptics signals from the metadata. That is, the metadata are applied as input to the machine learning (or deep learning) model.

The multi-media engine 112 receives or includes the spatial audio and/or video. The spatial audio and/or video are used to generate haptics information that is associated with the spatial audio and/or video. For example, a video scene of an explosion having accompanying audio of the explosion can be used to generate haptics information to cause a user's haptic vest, haptic gloves, and head-mounted display to vibrate/shake and blow air simulating wind on the user. Spatial audio, in particular, is useful for localizing the haptics information relative to the event (e.g., the explosion). This improves the immersive user experience of the digital environment.

The encoding engine 114 encodes the haptics information (the haptics signal or the haptics metadata) with the audio to generate a rendering package. The encoding engine 114 can also combine the encoded audio/haptics rendering package with the video such that the audio, video, and haptics information are time-synchronized. Thus, the rendering package can be played back (rendered) to a user, and the user experiences the audio, video, and haptics information together in the digital environment. As an example of haptics metadata, the user's device (i.e., a rendering device) parses and interprets the haptic metadata and uses that information to activate haptics devices associated with the user. The haptics signal(s) are routed to the appropriate haptic transducers by using metadata for each transducer. The metadata identifies to which transducer the associated haptic signal is to be routed. For example, the metadata could be set as fan=0, vest=1, left glove=2, etc.

FIG. 2 depicts a computing device for generating haptics signals and/or haptics metadata based at least in part on spatial audio and video according to examples described herein. Similarly to the computing device 100 of FIG. 1, the example computing device 200 of FIG. 2 includes a processing resource 202. Additionally, the computing device 200 includes a video/audio-driven haptics information generation module 210, a spatial audio authoring module 212, a video module 214, an integration module 216, and a package rendering module 218. These modules may be stored, for example, in a computer-readable storage medium (e.g., the computer-readable storage medium 404 of FIG. 4) or a memory (e.g., the memory resource 104 of FIG. 1), or the modules may be implemented using dedicated hardware for performing the techniques described herein.

The video/audio-driven haptics information generation module 210 generates haptics metadata using audio-haptics classification based at least in part on spatial audio associated with a digital environment. For example, audio-haptics classification is performed using machine learning and/or artificial intelligence techniques, such as deep learning, to classify audio and generate haptics information based on the audio, which is associated with the digital environment. As an example, audio may of an explosion. The audio-haptics classification classifies the audio as having a wind component and a vibration component. The video/audio-driven haptics information generation module 210 generates haptics metadata indicative of the wind component and the vibration component, which are used during playback (rendering) to cause sensors, such as a fan and an ERM actuator, to generate airflow and vibration haptics.

Examples of audio-haptics classification include: classification as wind in a complex sound source (or in raw audio asset) causes synthesis of fan-driven metadata fields with corresponding information about the wind (duration, direction, amplitude and modulation over time, and model-type) for creating haptics on rendering device; classification as an explosion in a complex sound source (or in raw audio asset) causes synthesis of vibration signal metadata; and/or classification as a touch-based event using video analysis causes synthesis of tactile signal metadata fora glove. In various examples of the present techniques, haptic feedback can vary by type of effect (e.g., fan, vibration, etc.), intensity of effect (e.g., low, high, etc.), orientation of effect (e.g., a fan blowing air on the left side of a user's face), and duration of effect (e.g., the effect lasts 0.1 second, 3 seconds, 10 seconds, etc.), waveform of effect (e.g., low-band waveform), and type of touch effect (e.g., touch effect applied separately to the hands or writs of a user).

According to an example, a separate stream of haptic information is provided that is simulated directly by game physics in a video game environment or at the direction of the game designer, both of which provide greater accuracy of effect and more fidelity in the type of experience to provide. In examples, haptic effects can come in several forms, of which haptic=1 (on) or haptic=0 (off) is one type. Other haptic effects include low-band waveform generated haptic effects applied to a non-specific part of the body, haptic touch effects applied separately to the hands or wrists, etc. To those haptics effects are added, such as haptic touch effects applied separately to the shoulders, wind effects applied directionally at four quadrants around the face and neck, and the like, and combinations thereof.

In some examples, to improve battery usage, the haptic effects default to an “off” state and are turned on for a limited duration, which can be extended by repeating the on command before it has expired. Because the haptic effects have a duration associated therewith, the effects can be moved from the appropriate haptic transducers at which they were initially started to other haptic transducers without waiting for expiry or canceling the previous haptic command. According to examples, similar to audio volume, haptic effects can vary in intensity such that the haptic effects can be increased and/or decreased. The intensity can be modified dynamically without having to cancel an effect or wait for the effect to expire.

The spatial audio authoring module 212 enables spatial audio generation. Spatial audio provides surround-sound in a 360-degree environment, such as a virtual reality, augmented reality, orvideo game environment. The audio generated during spatial audio is fed into the video/audio-driven haptics information generation module 210 and is used for audio-haptics classification to generate the haptics information.

The video module 214 provides video to the video/audio-driven haptics information generation module 210. In some examples, the video is also used for audio-haptics classification to generate the haptics information.

The integration module 216 receives an audio signal from the spatial audio authoring module 212 and receives the haptics information from the video/audio-driven haptics information generation module 210. The audio signal can be a down-mixed 2-channel audio signal or another suitable audio signal, and the haptics information can be a haptics signal and/or haptics metadata. The integration module 216 combines the audio signal and the haptics information, which can then be embedded by the package rendering module 218. In particular, the package rendering module 218 encodes the audio/haptics signal from the integration module 216. In some examples, the package rendering module 218 also encodes the video with the audio/haptics signal from the integration module 216 to generate a rendering package. The encoding can be lossy or lossless encoding. The rendering package can be sent to a user device (not shown) to playback the content, including presenting the audio, video, and haptics to the user.

FIG. 4 depicts a computer-readable storage medium 404 comprising instructions to generate haptics signals and/or haptics metadata based at least in part on spatial audio and video according to examples described herein. The computer-readable storage medium 404 is non-transitory in the sense that it does not encompass a transitory signal but instead is made up of storage components that store the instructions. The computer-readable storage medium may be representative of the memory resource 104 of FIG. 1 and may store machine-executable instructions in the form of modules or engines, which are executable on a computing device such as the computing device 100 of FIG. 1 and/or the computing device 200 of FIG. 2.

In the example shown in FIG. 4, the instructions include multi-media instructions 410, haptics instructions 412, and encoding instructions 414. The multi-media instructions 410 receive multi-media, such as spatial audio and/or video. The multi-media can be stored in the computer-readable storage medium 404 or another suitable storage device for storing data. The haptics instructions 412 generate haptics metadata and/or haptics signals using audio-haptics classification as described herein using a trained deep learning model, for example. The audio-haptics classification is based on the multi-media received by the multi-media instructions 410, which can include spatial audio associated with a digital environment and/or video associated with the digital environment. The encoding instructions 414 encode the spatial audio with the haptics metadata to generate a rendering package. The rendering package is used during playback of the multi-media to generate haptic feedback to a user experiencing the digital environment.

The instructions of the computer-readable storage medium 404 are executable to perform the techniques described herein, including the functionality described regarding the method 500 of FIG. 5. In particular, FIG. 5 depicts a flow diagram of a method 500 that generates haptics signals and/or haptics metadata based at least in part on spatial audio and video according to examples described herein. The method 400 is executable by a computing device such as the computing device 100 of FIG. 1 and/or the computing device 200 of FIG. 2. The method 500 is described with reference to the instructions stored on the computer-readable storage medium 404 of FIG. 4 and the components of the computing device 100 of FIG. 1 and/or the computing device 200 of FIG. 2 as an example but is not so limited.

At block 502 of FIG. 5, the haptics generation engine 110 generates haptics metadata using audio-haptics classification based at least in part on spatial audio associated with a digital environment. In some examples, the audio-haptics classification is performed using artificial intelligence or “deep learning.” The audio-haptics classification can be based on spatial audio in some examples or based on spatial audio and video in other examples.

In some examples, the audio-haptics classification includes extracting features from the audio. The audio-haptics classification can also include classifying haptics based at least in part on the extracted features from the audio using a neural network. The “haptics” indicate a class of haptics such as wind, vibration, etc. and a state, such as on or off, indicating whether the haptics are present. Results of the haptics classification are included in the haptics metadata. For example, the metadata can include a haptics classification of wind, along with a particular fan that is activated, a time that the fan is activated, a duration that the fan is activated, and the like. The audio-haptics classification can similarly extract features from the video and then classify haptics based at least in part on the extracted features from the video using a neural network.

According to some examples, the haptics generation engine 110 generates haptics signals instead of or in addition to the haptics metadata. The haptics signals can be a single or multi-channel signal. In the case of a multi-channel signal, each of the channels of the multi-channel signal can be associated with a haptics generating device to generate haptic feedback during playback of the rendering package. For example, one signal is associated with a haptics generating device in a left glove and another signal is associated with another haptics generating device in a right glove.

At block 504, the encoding engine 114 encodes the spatial audio with the haptics metadata to generate a rendering package. The encoding can be lossy or lossless encoding. In some examples, the encoded audio/video and haptics metadata can be combined with time-synchronized video to generate the rendering package.

Additional processes also may be included. For example, the audio-haptics classification comprises applying a machine-learning model to generate the haptics metadata

It should be understood that the processes depicted in FIG. 5 represent illustrations and that other processes may be added or existing processes may be removed, modified, or rearranged without departing from the scope of the present disclosure.

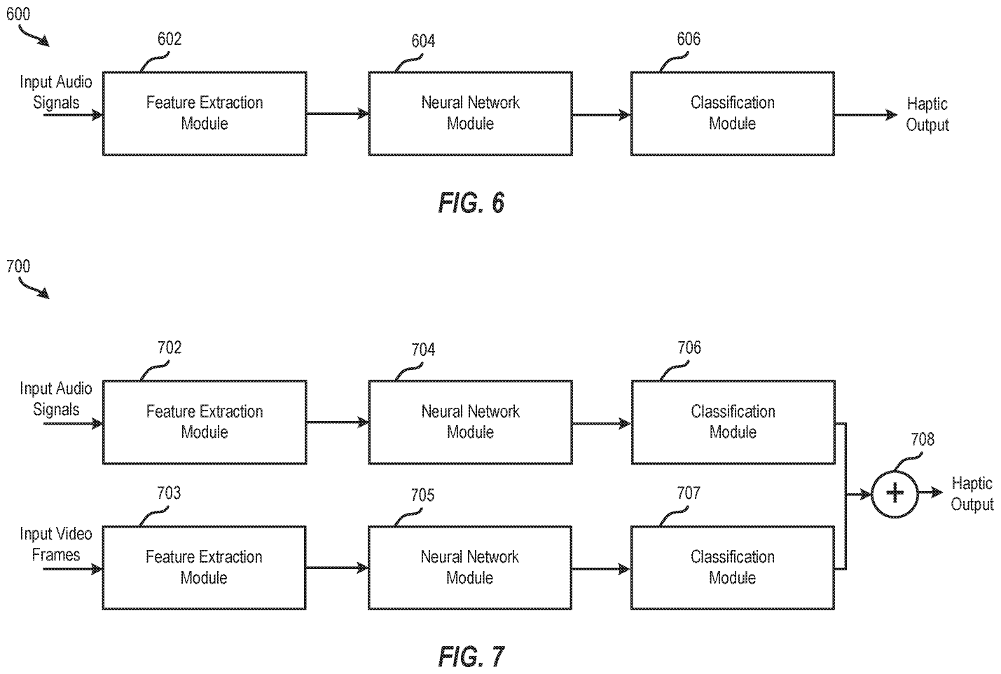

FIG. 6 depicts a flow diagram of a method 600 for performing audio-haptics classification based on spatial audio according to examples described herein. A feature extraction module 602 receives input audio signals (i.e., spatial audio). The feature extraction can be performed using a convolutional neural network, an autoencoder, long short-term memory, hand-designed features, or a combination thereof. The input audio signals can be mono audio sources {x_{1,k}(n), x_{2,k}(n), . . . , x_{M,k}(n)} where k is a frame index and n is the sample in the frame for audio source P in x_{P,k}(n). These are used by the neural network module 604 initially to perform labeled training of a deep learning model. The classification module 606 then generates predicted labels (i.e., classifications) using the trained deep learning model. The predicted labels applied during training, per frame, are hₖ={0,1}, where 0 is no haptics and 1 indicates that haptics are present at that frame. A haptic value of 1 implies a specific discrete event type has been recognized. For example, a waving flag that is visible to the user and recognizable from the training data could be mapped to a discrete haptic event such as wind, forward facing, applied for fifteen seconds. As another example, if an explosion is recognized from the training data, the explosion is mapped to a discrete waveform applied at the shoulders of the user. The actual mapping from a recognized scene element to a particular haptic effect can be implemented using a table lookup of the recognized event to an equivalent haptic effect, for example. The haptic signal, based on the audio-haptics classification, is then embedded with the audio signal to generate a rendering package as described regarding block 218 of FIG. 5.

FIG. 7 depicts a flow diagram of a method 700 for performing audio-haptics classification based on spatial audio and video according to examples described herein. A feature extraction module 702 receives input audio signals (i.e., spatial audio). The feature extraction can be performed using a convolutional neural network, an autoencoder, long short-term memory, hand-designed features, or a combination thereof. The input audio signals can be mono audio sources {x_{1,k}(n), x_{2,k}(n), . . . , x_{M,k}(n)} where k is a frame index and n is the sample in the frame for audio source P in x_{P,k}(n). These are used by the neural network module 704 initially to perform labeled training of a deep learning model. The classification module 706 to generate predicted labels (i.e., classifications) using the trained deep learning model. A deep learning model can be trained to output haptic=1 when audio content such as explosions or wind blowing is present, for example, and haptic=0 when no haptic is present. A haptic value of 1 implies a specific discrete event type has been recognized. For example, a waving flag that is visible to the user and recognizable from the training data could be mapped to a discrete haptic event such as wind, forward facing, applied for fifteen seconds. As another example, if an explosion is recognized from the training data, the explosion is mapped to a discrete waveform applied at the shoulders of the user. The actual mapping from a recognized scene element to a particular haptic effect can be implemented using a table lookup of the recognized event to an equivalent haptic effect, for example.

A feature extraction module 703 receives input video scenes. The video scenes are extracted on a frame-by-frame basis, for example at approximately 29.97 frames per second. Pre-trained models, such as ResNet or ImageNet can be trained by the neural network module 705, and the classification module 707 classifies or identifies scene descriptions, such as explosions, wind, touching of objects (e.g., for use with haptic gloves), and the like. The predicted labels applied during training, per frame, are hₖ={0,1}, where 0 is no haptics and 1 is a haptic signal to be applied for that frame. A haptic value of 1 implies a specific discrete event type has been recognized. For example, a waving flag that is visible to the user and recognizable from the training data could be mapped to a discrete haptic event such as wind, forward facing, applied for fifteen seconds. As another example, if an explosion is recognized from the training data, the explosion is mapped to a discrete waveform applied at the shoulders of the user. The actual mapping from a recognized scene element to a particular haptic effect can be implemented using a table lookup of the recognized event to an equivalent haptic effect, for example.

The haptic signal for the audio and the haptic signal for the video is then combined at block 708 to generate haptic output, which is then embedded with the audio signal to generate a rendering package as described regarding block 218 of FIG. 5.

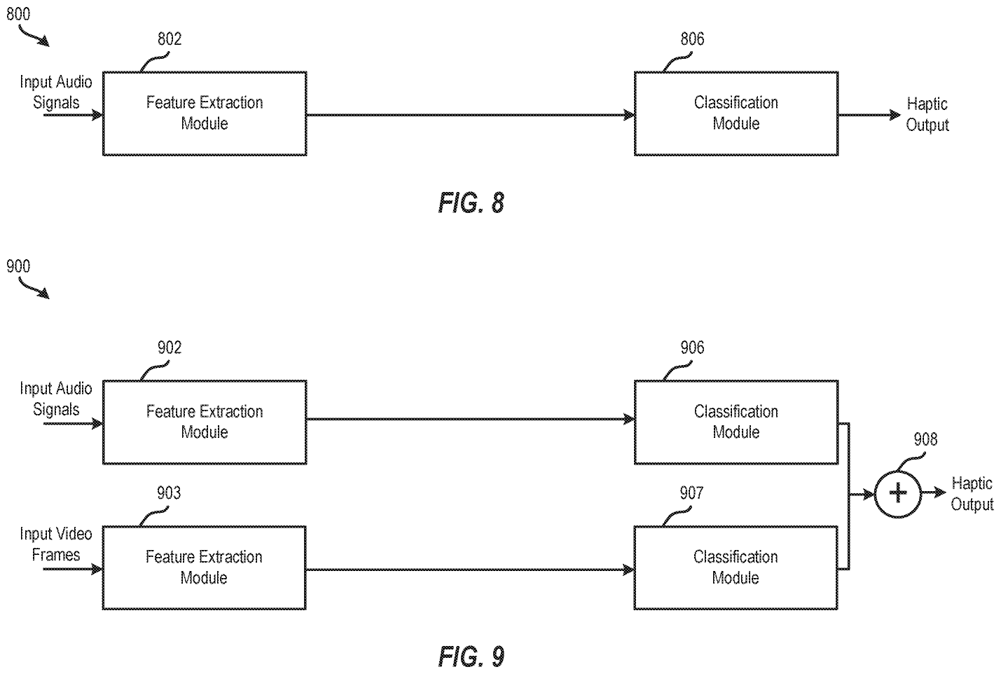

FIG. 8 depicts a flow diagram of a method 800 for performing audio-haptics classification based on spatial audio according to examples described herein. A feature extraction module 802 receives input audio signals (i.e., spatial audio). The feature extraction can be performed using a convolutional neural network, an autoencoder, long short-term memory, hand-designed features, or a combination thereof. The input audio signals can be mono audio sources {x_{1,k}(n), x_{2,k}(n), . . . , x_{M,k}(n)} where k is a frame index and n is the sample in the frame for audio source P in x_{P,k}(n). The extracted features are used to classify haptics by the classification module 806 using a previously trained deep learning model.

In particular, the classification module 806 generates predicted labels (i.e., classifications) using the trained deep learning model. The predicted labels applied during training, per frame, are hₖ={0,1}, where 0 is no haptics and 1 indicates that haptics are present at that frame. A haptic value of 1 implies a specific discrete event type has been recognized as described herein. The actual mapping from a recognized scene element to a particular haptic effect can be implemented using a table lookup of the recognized event to an equivalent haptic effect, for example. The haptic signal, based on the audio-haptics classification, is then embedded with the audio signal to generate a rendering package as described regarding block 218 of FIG. 5.

FIG. 9 depicts a flow diagram of a method 900 for performing audio-haptics classification based on spatial audio and video according to examples described herein. A feature extraction module 902 receives input audio signals (i.e., spatial audio) and performs feature extraction to extract features of the audio signals. A classification module 906 generates predicted labels (i.e., classifications) using a previously trained deep learning model.

A feature extraction module 903 receives input video scenes. The video scenes are extracted on a frame-by-frame basis, for example at approximately 29.99 frames per second. The classification module 907 classifies or identifies scene descriptions, such as explosions, wind, touching of objects (e.g., for use with haptic gloves), and the like, using the trained deep learning model, for example. The predicted labels applied during training, per frame, are hₖ={0,1}, where 0 is no haptics and 1 is a haptic signal to be applied for that frame. A haptic value of 1 implies a specific discrete event type has been recognized. The actual mapping from a recognized scene element to a particular haptic effect can be implemented using a table lookup of the recognized event to an equivalent haptic effect, for example.

The haptic signal for the audio and the haptic signal for the video is then combined at block 908 to generate haptic output, which is then embedded with the audio signal to generate a rendering package as described regarding block 218 of FIG. 5.

It should be emphasized that the above-described examples are merely possible examples of implementations and set forth for a clear understanding of the present disclosure. Many variations and modifications may be made to the above-described examples without departing substantially from the principles of the present disclosure. Further, the scope of the present disclosure is intended to cover any and all appropriate combinations and sub-combinations of all elements, features, and aspects discussed above. All such appropriate modifications and variations are intended to be included within the scope of the present disclosure, and all possible claims to individual aspects or combinations of elements or steps are intended to be supported by the present disclosure.

What is claimed is:

1. A non-transitory computer-readable storage medium comprising instructions that, when executed by a processing resource of a computing device, cause the processing resource to:
generate haptics metadata using audio-haptics classification based at least in part on spatial audio associated with a digital environment; and
encode the spatial audio with the haptics metadata to generate a rendering package.

2. The non-transitory computer-readable storage medium of claim 1, wherein the audio-haptics classification comprises applying a machine-learning model to generate the haptics metadata.

3. The non-transitory computer-readable storage medium of claim 1, wherein the audio-haptics classification comprises extracting features from the audio.

4. The non-transitory computer-readable storage medium of claim 3, wherein the audio-haptics classification comprises classifying haptics based at least in part on the extracted features from the audio using a neural network, wherein the haptics metadata comprises the haptics.

5. The non-transitory computer-readable storage medium of claim 1, wherein the encoding applies a lossless-based encoding technique.

6. The non-transitory computer-readable storage medium of claim 1, wherein the encoding applies a lossy-based encoding technique.

7. The non-transitory computer-readable storage medium of claim 1, generating the haptics metadata is further based at least in part on video associated with the digital environment.

8. The non-transitory computer-readable storage medium of claim 7, wherein the audio-haptics classification comprises extracting features from the video.

9. The non-transitory computer-readable storage medium of claim 8, wherein the audio-haptics classification comprises classifying haptics based at least in part on the extracted features from the video using a neural network, wherein the haptics metadata comprises the haptics.

10. A method comprising:
generating a haptics signal using audio-haptics classification based at least in part on spatial audio and video associated with a digital environment; and
encode the spatial audio with the haptics signal to generate a rendering package.

11. The method of claim 10, wherein the audio-haptics classification comprises applying a machine-learning model to generate the haptics signal.

12. The method of claim 10, wherein the haptics signal comprises a plurality of channels, each of the plurality of channels being associated with a haptics generating device to generate haptic feedback during playback of the rendering package.

13. A computing device comprising:
a processing resource to:
generate haptics metadata using audio-haptics classification based at least in part on spatial audio and video associated with a digital environment;
encode the spatial audio with the haptics metadata; and
combine the encoded spatial audio and haptics metadata with the video to generate a rendering package.

14. The computing device of claim 13, wherein the audio-haptics classification comprises extracting features from the audio and classifying haptics based at least in part on the extracted features from the audio using a neural network, wherein the haptics metadata comprises the haptics.

15. The computing device of claim 13, wherein the audio-haptics classification comprises extracting features from the video and classifying haptics based at least in part on the extracted features from the video using a neural network, wherein the haptics metadata comprises the haptics.
